(19) United States
(12) Patent Application Publication
(10) Pub. No.: US 2026/0119641 A1
(43) Pub. Date: Apr. 30, 2026

(54) PASSWORD HINT MANAGEMENT SYSTEM WITH USER-GENERATED AND AUTO GENERATED PASSWORD HINTS

(71) Applicant: Ryan Charles Leschensky, Encinitas, CA (US)

(72) Inventor: Ryan Charles Leschensky, Encinitas, CA (US)

(21) Appl. No.: 18/927,711

(22) Filed: Oct. 25, 2024

(51) Int. Cl. G06F 21/46

(52) U.S. Cl. CPC G06F 21/46

(57) ABSTRACT

A password management system is disclosed that helps users recall passwords by providing both user-generated and automatically generated hints. Users can record voice or written hints that do not store the password but offer clues to help recall it. In an alternative embodiment, the system automatically analyzes the password or the password requirements of the website and generates a hint that describes the password's parameters (e.g., number of characters, capitalization, use of special symbols). These hints are stored securely and can be retrieved when the user needs to enter the password.

### BACKGROUND

In today's digital age, individuals are increasingly required to manage numerous online accounts, each secured by a unique password. Modern security standards often mandate that passwords consist of complex combinations of upper- and lowercase letters, numbers, and special characters. While these requirements are important for enhancing security, they have also led to significant frustration among users. The complexity of passwords, coupled with the frequent need for updates and resets, has made password management a cumbersome task for many.

Faced with the challenge of remembering and managing a large number of complex passwords, many individuals adopt insecure practices to make the process easier. For instance, it is common for users to reuse the same password across multiple accounts or to create overly simple passwords that are easier to memorize. Such practices increase the risk of security breaches and unauthorized access to sensitive personal information. Additionally, in the absence of adequate password management tools, some users may resort to even riskier behaviors, such as writing down passwords or storing them in unencrypted text files. These insecure methods further expose individuals to potential identity theft, fraud, and data breaches.

Older adults often face unique challenges when it comes to managing and recalling passwords. Cognitive decline, such as memory loss or slower recall, can make it harder to remember complex passwords, especially with modern security standards that demand a mix of characters, numbers, and special symbols. Additionally, older adults may have less familiarity or comfort with newer technologies, making third-party password managers or reset mechanisms more intimidating and difficult to navigate.

There is a need for a more user-friendly solution that would streamline the password recall process, reducing the cognitive load on users, and promote a higher level of security by eliminating the need for insecure memorization practices.

### SUMMARY OF THE INVENTION

The present invention provides password management system designed to assist users in recalling their passwords through user-generated, automatically generated hint information, or a combination of both. This system addresses the widespread issue of password fatigue and security risks associated with forgotten or insecure passwords. The present invention offers users multiple options for creating secure, personalized hints for recalling their passwords, thereby improving both convenience and security.

In one aspect, the system allows users to create a customized hint at the time of setting a password. This hint can be recorded either in written form or as a voice memo and can include personalized information designed to aid the user in recalling the specific password. The flexibility of the system permits the hint to be stored in a way that aligns with the user's preferences, making it easy to retrieve the hint when attempting to log in to the associated account or service.

In another aspect, the password management system of the invention further enhances password recall by offering automatic generation of password hints. The automatically generated password hints may be based on the structure of the password or on the requirements of the platform on which the password is being used. The system analyzes the structure of the password, or the specific password criteria set by the site or app (such as minimum length, required use of capital letters, numbers, and special characters), and generates a password parameter hint. This parameter hint could include details such as “the password has 8 characters, 1 capital letter, 3 numbers, and 1 special symbol,” or “the password criteria does not allow the # or % character,” which provides enough information to allow the user to recall the structure and rules for their password without exposing the actual password.

Once created, the personalized hint, the password parameter hint, or both, are stored in the system. When the user attempts to log into the corresponding account, the system retrieves and displays or plays the appropriate hint, aiding in the recall process without compromising security. The system ensures that the hints are provided in a secure and non-intrusive manner, helping users remember their password without revealing sensitive information to unauthorized parties.

By providing these multiple recall options, the password management system of the present invention significantly reduces the cognitive burden on users who struggle to remember complex passwords while simultaneously enhancing security. The system's ability to generate objective password parameter reminders, alongside personalized hints, ensures that users can recall their passwords in a secure and efficient manner. The invention ultimately improves password management by addressing the common problems associated with password complexity and recall, offering a user-friendly and secure solution adaptable to various platforms and devices.

### DETAILED DESCRIPTION

The password management system designed to assist users in recalling their passwords through user-generated hints, auto-generated hints or both. The system makes use of a system that records and stores user-generated hints, generates and stores auto-generated password hints, or both, to be recalled at a later time, e.g., upon request by the user or when a password has been entered incorrectly. By addressing the common challenges associated with password management, this software provides intuitive and secure methods for users to create, store, and recall password hints, thereby improving both convenience and security.

The password management system enables users to create and store personalized, user-generated password hints in either written or spoken form. These hints are designed to provide cues that help users recall their passwords without directly revealing the passwords themselves, thereby enhancing security while aiding memory retention.

When a user sets a password, the system prompts them to record a vocal hint related to the password's content. For instance, the user might record a message such as, “This password is related to my dog's birthday” or “It contains three numbers and a special symbol.” This voice recording is then securely stored and associated with the specific site or application for which the password was created.

The password management system offers flexibility in how these recordings are stored. Users can choose to save the voice recording locally on their device, on a network storage location, or in a cloud environment, depending on their preferences and security requirements. When the user needs to recall the password, they can navigate to the relevant site or application within the software interface. The voice recording is then played back, helping the user recall the password without exposing the actual content of the password itself. This approach is particularly useful for users who may remember passwords more easily through auditory cues rather than purely textual prompts. See Schine J. Movement, memory & the senses in soundscape studies. Canadian Acoustics. 2010 Sep. 1; 38(3):100-1; Marian V, Hayakawa S, Schroeder SR. Cross-modal interaction between auditory and visual input impacts memory retrieval. Frontiers in Neuroscience. 2021 Jul. 26; 15:661477.

Alternately, a user may opt to create a textual hint instead of a voice recording. The system allows users to type personalized hints such as “Think about Billy's school” or “It's the vacation spot where I saw a magician.” These written hints are stored in association with the corresponding password and can be retrieved within the password management system when the user attempts to access the specific site or application. This provides flexibility for users who prefer written reminders, offering an additional method for recalling passwords securely and effectively.

The password management system of the present invention may also generate hints automatically based on the structure of the password or the password requirements of a particular website or application. When a password is created, the system analyzes its characteristics and generates a password parameter hint. For example, if the password is “Pa$$w0rd123,” the system might generate a hint like, “Your password has 8 characters, 1 capital letter, 3 numbers, 1 special symbol.” This hint helps users recall the structural elements of the password without revealing the actual characters, thereby preserving security while providing useful memory cues.

Additionally, the password management system can integrate directly with websites and applications to analyze their specific password requirements. For instance, if a particular site requires a password with “at least 12 characters, including 1 capital letter, 1 lower case letter and 1 special symbol,” the system records these requirements as a hint associated with that site. When the user attempts to log in, the system automatically retrieves and displays the relevant password parameters, e.g., “This site requires passwords with 12 characters, including 1 capital letter, 1 lower case letter and 1 special symbol,” helping the user recall the appropriate format for that platform's password. This automatic hint generation is particularly valuable for users who manage multiple accounts, each with different password rules, and need assistance recalling which password format is required for which site.

To ensure the security of the stored hint information, the password management system of the present invention may incorporate additional protective measures. For example, the system may include biometric authentication methods such as fingerprint scanning or facial recognition to ensure that only authorized users can access the hint information. This additional layer of protection guarantees that the password hints remain secure and accessible only to the legitimate user, further safeguarding sensitive information. In a typical embodiment, for example, a hint is stored securely on cloud and linked to an account; the user has a desktop app or extension for their web-browser in which they authenticate themselves with a master-password at which point they are given access to all the hints.

In some embodiments, user-generated and auto-generated hints may be stored in an encrypted format. This ensures that even in the event of unauthorized access to the storage medium, the hint data remains secure and unreadable without the proper decryption key. The encrypted storage mechanism adds an extra level of privacy and security of the user's password hints, aligning with industry standards for data protection.

In some embodiments, the system can offer cross-device synchronization capabilities for users who use the password management tool across multiple devices, such as smartphones, tablets, and computers, by any method known in the art. Cross-device synchronization allows that password hint information to be accessible from any device the user chooses to access, whether at home, in the office, or while traveling. Synchronization preferably occurs securely, employing encrypted communication protocols to maintain the integrity and confidentiality of the data during transmission. In this way, users can seamlessly retrieve stored hints from any of their devices, enhancing convenience without compromising security.

By allowing users to generate personalized hints and offering auto-generated password hints, the system simplifies the password recall process without compromising security. Furthermore, the use of encryption, biometric authentication, and secure synchronization protocols ensures that the system maintains the highest levels of security for the user's data. Whether the user prefers voice, text, or automated hints, the password management system of the present invention adapts to various needs and offers flexibility for effective and secure password management across multiple platforms and devices.

To ensure security, the hints generated by the system do reveal any part of the actual password. Rather the user-generated hint should be personalized, having meaning to the user but not others. Similarly, while providing useful information, such as the number of characters or the types of symbols used, the auto-generated hints do not divulge specific characters or sequences. In this way, even if the hint is accessed improperly, it cannot be used to directly guess the password. In case the password is updated, the system automatically re-analyzes the new password and generates a new hint, reflecting the updated password's structure or requirements.

Additionally, users have the flexibility to choose how detailed they want the auto-generated hints to be. Some users might prefer general hints that focus only on certain aspects, such as the number of special characters, while others might opt for a more comprehensive breakdown of the password's structure. The system accommodates these preferences, offering customizable options that balance convenience with security.

By generating automatic hints based on either password structure or platform requirements, this invention provides an efficient and secure solution for recalling complex passwords. Automatic hint generation mitigates the need for insecure practices such as writing down passwords or using overly simple ones, all while enhancing the security of user accounts across multiple platforms.

When using the system on a desktop computer, users can install a dedicated software application or access the system via a web browser. The desktop version allows users to set and retrieve both user-generated and auto-generated password hints for their accounts. Users can create personalized voice or written hints when setting passwords and store them securely within the system.

On the desktop platform, the system supports secure local storage for password hints, encrypting all data to prevent unauthorized access. In addition to local storage, users have the option to sync the data with network or cloud-based storage to ensure that their password hints are accessible from other devices.

The password hint management system is also available as a mobile application on smartphones and tablets. Mobile integration provides users with the ability to access and manage their password hints conveniently from their mobile devices. The mobile application can prompt users to record voice hints using the device's microphone or type text hints using the touchscreen keyboard.

The system ensures that password hints are securely stored on the mobile device, using encryption to protect sensitive data. The mobile version of the system supports biometric authentication (e.g., fingerprint or facial recognition) to verify the identity of the user before allowing access to password hints, further enhancing security. The app also synchronizes password hint information with cloud storage or the user's network, ensuring that data is consistent across devices.

In a networked environment, such as within a business or organization, the system can be integrated with a network-based storage solution. This allows users to store their password hints on a secure, centralized server accessible over the network. In this configuration, employees or team members can retrieve their password hints from any connected device within the organization, including desktops and mobile devices, without needing to store hints locally on each device.

Network-based storage enables administrators to manage and control access to password hints using predefined security policies. All password hint data stored on the network is encrypted, and access to the system can be secured using multi-factor authentication (MFA) or other advanced security measures. The system can also be configured to log access events, providing an audit trail for security purposes.

The password hint management system is also compatible with cloud-based storage solutions. Users can choose to store their password hints in a secure cloud environment, enabling them to access their hints from anywhere with an internet connection. Cloud storage offers the advantage of scalability, allowing users to store a virtually unlimited number of password hints without needing to worry about local storage limitations.

When utilizing cloud storage, the system employs encryption both at rest and in transit, ensuring that password hints are protected during transmission between the user's device and the cloud server. The system also integrates with leading cloud storage providers, allowing users to link their accounts with services such as Google Drive, Microsoft OneDrive, or Dropbox, depending on their preference.

Cloud-based storage is particularly beneficial for users who manage multiple devices, as it allows for automatic synchronization of password hints across all devices. Changes made on one device, such as creating or editing a password hint, are automatically reflected on all other connected devices. Cloud storage also provides backup capabilities, ensuring that password hints remain recoverable in the event of a device loss or failure.

By offering compatibility across desktops, mobile devices, network-based storage, and the cloud, the password hint management system provides users with the flexibility to manage and access their password hints from any location or platform. Regardless of whether users prefer local storage, network environments, or cloud-based solutions, the system maintains a high level of security through encryption, biometric authentication, and synchronization capabilities, ensuring that password hints are both accessible and protected across all devices.

### EXAMPLES

The following examples are provided to illustrate specific embodiments of the present invention and to demonstrate the methods and advantages of the invention as described. However, these examples are not intended to limit the scope of the invention, which is defined by the claims and encompasses various modifications and variations that will be apparent to those skilled in the art. The invention may be practiced in a variety of forms beyond those explicitly described in these examples, and such variations are considered to be within the scope of the invention.

### Example 1: Personalized Voice Hint for Password Recall

The subject is an active user of various online services, including social media, online banking, and shopping platforms. To ensure the security of her accounts, each platform requires her to create a unique and complex password with a combination of letters, numbers, and symbols. The subject often struggles to remember these passwords, especially when they need to be updated frequently. To simplify this process, she uses the present password management system.

When the subject creates a new password for her online banking account, the system prompts her to generate a personalized hint. She decides to record a voice hint, saying, “This password is related to my dog's birthday and has a special symbol at the end.” The voice recording is stored securely within the system and associated with the online banking account.

Two weeks later, the subject attempts to log in to her online banking account but cannot recall the exact password. She opens the password management tool, selects the online banking account, and the system automatically plays back her recorded voice hint. Hearing her own voice say, “This password is related to my dog's birthday and has a special symbol at the end,” she remembers the password and successfully logs into her account without needing to reset or retrieve the actual password itself.

The voice hint provides an intuitive, secure way for the subject to recall her password while protecting the actual password from exposure.

### Example 2: Auto-Generated Password Parameter Hint

A subject frequently uses different websites that each require passwords with varying levels of complexity. For instance, one of the sites he visits requires a password with at least 10 characters, including 2 capital letters, 3 numbers, and 1 special symbol. He finds it difficult to remember the structure of each password, especially when multiple sites have different rules.

When the subject creates a new password for this site, the password management system analyzes the password's structure and generates an automatic password parameter hint: “10 characters, 2 capital letters, 3 numbers, 1 special symbol.” This hint is stored alongside the password in the system.

Later, when the subject returns to the site but cannot remember the exact characters of his password, he uses the password management tool. The system retrieves the associated password parameter hint and displays, “This password requires 10 characters, 2 capital letters, 3 numbers, 1 special symbol.” With this information, the subject quickly recalls the password's format and successfully logs in without needing to reset his password or expose its actual content.

This automatic hint generation helps the subject recall the password structure without jeopardizing its security, making the login process more efficient.

1. A password management system, comprising: (i) A recording module configured to receive and store hint information related to a password, and (ii) A retrieval module configured to provide access to the stored voice-recorded hint information upon user request, wherein the hint information is recorded by a user at the time of setting the password and wherein the retrieval module does not store the password itself.

2. The password management system of claim 1, wherein the hint information is voice-recorded hint information.

3. A password management system, comprising: (i) A password analysis module configured to analyze a password set by the user and automatically generate a password parameter hint that describes characteristics of the password; and (ii) A retrieval module configured to display the password parameter hint when the user attempts to enter the password for a specific site or app, wherein the password parameter hint is stored and displayed to the user upon request.

4. A password management system, comprising: (i) A password requirement analysis module configured to analyze the password requirements of a website or application and automatically generate a password requirement hint describing those requirements; and (ii) A retrieval module configured to display the password requirement hint when the user attempts to enter the password for the specific website or application.
